(19) United States
(12) Patent Application Publication
(10) Pub. No.: US 2026/0326250 A1
(43) Pub. Date: Oct. 22, 2026

(54) CUT DEPTH ADJUSTMENT SYSTEMS FOR CNC ROUTERS

(71) Applicant: Maslow CNC LLC, Port Townsend, WA (US)

(72) Inventor: Barbour SMITH, Port Townsend, WA (US)

(21) Appl. No.: 19/646,209

(22) Filed: Apr. 13, 2026

Related U.S. Application Data
(60) Provisional application No. 63/792,629, filed on Apr. 22, 2025.

(51) Int. Cl. B23Q 15/24; B27C 5/02

(52) U.S. Cl. CPC B23Q 15/24; B27C 5/02

(57) ABSTRACT

Disclosed embodiments are directed to cut depth adjustment systems that utilize a set of motors to both rotate a cutting tool and adjust a cut depth of the cutting tool. The system includes at least a first motor and a second motor having coaxially aligned threaded center holes with differing thread characteristics, and a threaded shaft configured to simultaneously engage the threaded center holes. Coordinated rotation of the motors at substantially the same speed produces rotational output of the shaft to drive the cutting tool while maintaining a substantially constant axial position. Differential rotational operation of the motors produces axial translation of the shaft to adjust cut depth. The system may include control frameworks and/or additional motors to improve precision and reduce backlash.

### CROSS-REFERENCE TO RELATED APPLICATIONS

This application claims priority to and the benefit of U. S. Provisional Patent Application Serial No. 63/792,629, filed on Apr. 22, 2025, and entitled “CUT DEPTH ADJUSTMENT SYSTEMS FOR CNC ROUTERS”, the entirety of which is incorporated herein by reference for all purposes.

### BACKGROUND

CNC (computer numerical control) routers are used extensively in manufacturing and woodworking industries to automate cutting, carving, drilling, milling and/or other processes for a variety of materials. The use of CNC routers typically involves CAD (computer-aided design) and CAM (computer-aided manufacturing) software, enabling CNC routers to create physical objects from digital designs in an accurate, repeatable, and/or versatile manner.

CNC routers typically include one or more cutting tools (or spindles), stepper motors, drive systems, and controllers. Cutting tools of CNC routers spin at high speeds (e.g., 5,000–30,000 rpm) to cut into or through materials. Stepper motors control the movement of the cutting tool (e.g., based on program instructions), and drive systems convert the rotational motion of the stepper motors into linear motion along one or more axes to cause the cutting tool to traverse a designated path. Drive systems often include lead screws or chains to perform such functions. Controllers can include or interact with processing circuity and/or computer memory to interpret CAD and/or CAM data to control operation of the stepper motor(s) and other componentry of the CNC router.

The subject matter described herein is not limited to embodiments that operate only in environments such as those described above. Rather, this background is only provided to illustrate one example technology area where some embodiments described herein may be practiced.

### BRIEF DESCRIPTION OF THE DRAWINGS

Reference will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures are not necessarily drawn to scale.

FIG. 1A and 1B illustrate an example belt-driven CNC router, in accordance with implementations of the disclosed subject matter.

FIG. 2 illustrates a conceptual representation of an example cut depth adjustment system for a belt-driven CNC router, in accordance with implementations of the disclosed subject matter.

FIG. 3 illustrates a sectional view of example motors of a cut depth adjustment system, in accordance with implementations of the disclosed subject matter.

FIG. 4 illustrates an example threaded shaft of a cut depth adjustment system, in accordance with implementations of the disclosed subject matter.

FIG. 5 illustrates a sectional view of the threaded shaft of FIG. 4, in accordance with implementations of the disclosed subject matter.

FIG. 6 illustrates a sectional view of an example cut depth adjustment system, in accordance with implementations of the disclosed subject matter.

FIG. 7 illustrates a model of the cut depth adjustment system of FIG. 6, in accordance with implementations of the disclosed subject matter.

FIG. 8 illustrates an example flow diagram depicting acts associated with implementations of the disclosed subject matter.

### DETAILED DESCRIPTION

The disclosed subject matter relates to cut depth adjustment systems.

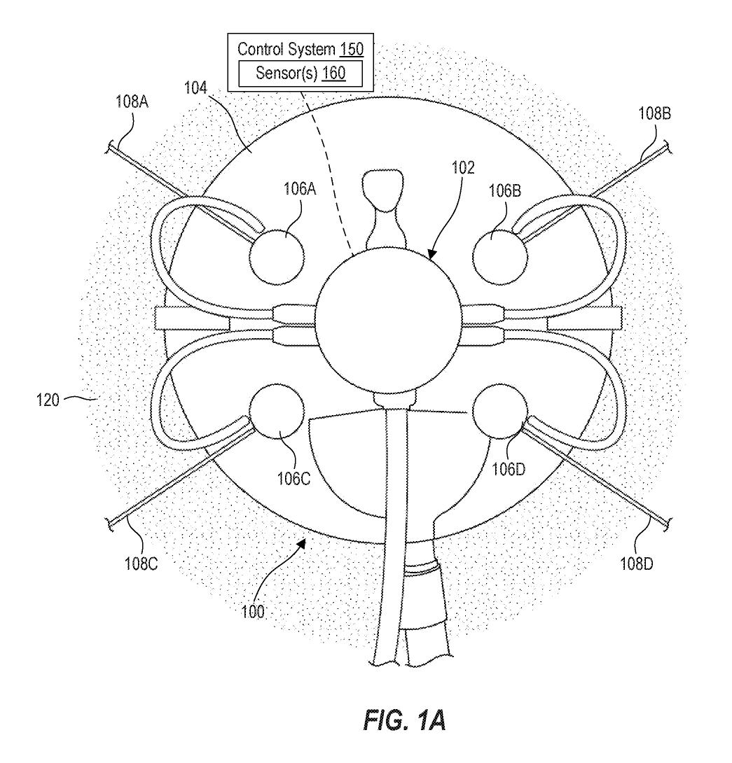

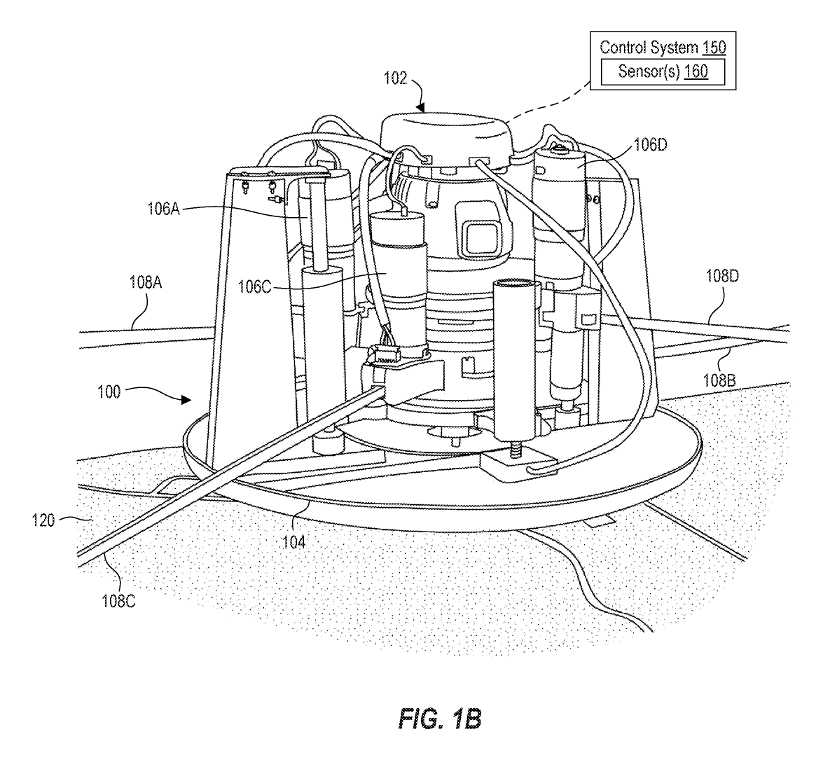

As noted above, CNC routers are used in numerous industries. Many traditional CNC routers occupy substantial floor space and operate on horizontal planes (e.g., with a workpiece arranged horizontally and with the cutting tool being arranged/moved thereover). In contrast with conventional CNC routers, belt-driven CNC routers (or angled-plane CNC routers) are configured to operate on workpieces oriented at multiple angles (e.g., horizontal, off-horizontal, or nearly vertical angles). FIGS. 1A and 1B illustrate an example belt-driven CNC router 100 arranged over a workpiece 120. In the example shown in FIGS. 1A and 1B, the belt-driven CNC router 100 includes a router carriage 102 on which the cutting tool and various components are disposed. The router carriage 102 is mounted on a sled 104, which can allow the router carriage 102 to move across the surface of the workpiece 120 in a stable, controlled manner. The cutting tool can be positioned on the router carriage 102 at a generally central location and can extend through an opening in the sled 104 toward the workpiece 120.

In the example shown in FIG. 1A and 1B, the belt-driven CNC router 100 also includes belt drive system that is driven by actuators 106A, 106B, 106C, and 106D mounted on the router carriage 102. The actuators 106A, 106B, 106C, and 106D can comprise servo motors, stepper motors, or other types of actuation mechanisms. The actuators 106A, 106B, 106C, and 106D manipulate movement of the router carriage 102 over the workpiece 120 by extending and retracting corresponding belts 108A, 108B, 108C, and 108D. As used herein, the term “belt” can refer to any type of elongated mechanical linkage or coupling, such as one or more belts, chains, cables, ropes, combinations thereof, etc. A belt-driven CNC router can thus incorporate any types of elongated mechanical linkages or couplings. The corresponding belts 108A, 108B, 108C, and 108D may be anchored/affixed to surfaces (e.g., flat-rated surfaces) in the surrounding environment or working area. Gravity may be leveraged to secure the router carriage 102 and the sled 104 against the workpiece 120 during movement and cutting operations. A belt-driven CNC router 100 can achieve various benefits relative to conventional flat CNC machines, such as reduced machine footprint, low cost, and the ability to work on large sheets of material (e.g., plywood).

In belt-driven CNC routers, achieving different cutting depths (or controlling the z-axis position of the cutting tool) is associated with various challenges. As used herein, “cut depth” may refer to a positional relationship of the cutting tool along an axis relative to a reference surface, structure, or coordinate system (e.g., relative to the sled, router carriage, workpiece surface, and/or a defined coordinate frame of the CNC system). For instance, a belt-driven CNC router (e.g., similar to the belt-driven CNC router 100 shown in FIGS. 1A and 1B) may incorporate linear actuators to selectively increase or decrease the distance between the router carriage (e.g., similar to router carriage 102) and the sled (e.g., similar to sled 104), which can modify the extension or retraction of the cutting tool through the opening of the sled toward the workpiece. To be able to reposition the entire router carriage (and all components mounted thereto) relative to the sled to achieve different cutting depths, the linear actuators typically comprise large and/or complex devices. Furthermore, because the actuators of belt-driven CNC routers (e.g., similar to actuators 106A, 106B, 106C, and 106D) are typically arranged on the router carriage, adjustment of the cutting depth of the cutting tool may also cause repositioning of the actuators and the corresponding belts (e.g., similar to belts 108A, 108B, 108C, and 108D). This can increase the difficulty associated with maintaining precise cutting functionality and can correspondingly increase the complexity of the software for operating belt-driven CNC routers.

At least some disclosed embodiments are directed to a cut depth adjustment system for CNC routers. A cut depth adjustment system can include a set of independently controlled motors (e.g., two or more) that each engage with and drive a common central shaft. The central shaft can include two (or more) distinct thread patterns and can be coupled to a cutting tool. When the motors of the set of motors rotate at the same speed (in the same direction), the central shaft may rotate without changing the cut depth of the cutting tool relative to the motors (e.g., to perform cutting operations with a substantially constant cut depth). When the motors rotate at different speeds, the cut depth of the cutting tool relative to the motors may change. The cut depth of the cutting tool may be precisely controlled by controlling the difference in the rotational speeds and/or rotational directions of the motors. The cut depth adjustment system may be configured to convert coordinated rotational input from multiple motors into axial displacement of a shaft while maintaining rotational output of a cutting tool. For instance, differential rotational characteristics between motors may be translated into linear movement of the shaft along a central axis, while simultaneous rotational motion of the shaft enables cutting operations. Such coordinated operation may allow a single set of motors to provide both rotational drive and axial positioning functionality for a cutting tool. In some implementations, the set of motors may be configurable to operate under different operating conditions, including (i) a first operating condition in which coordinated rotation of the motors produces rotational output of the shaft while maintaining a substantially constant axial position and (ii) a second operating condition in which differential rotational operation between the motors produces axial displacement of the shaft to adjust cut depth. In some implementations, operation of the motors may be configured such that one motor of the set of motors maintains a substantially constant rotational speed to provide a primary rotational drive for the cutting tool, while one or more additional motors are controlled to vary their rotational speeds relative to the primary motor to selectively adjust the cut depth.

As used herein, in the context of motors of cut depth adjustment systems as described herein, the term “coordinated rotation” refers to operation of two or more motors in a manner such that the motors rotate at substantially the same rotational speed and in a same rotational direction, and the term “differential rotation” (or “differential rotational operation”) refers to operation of two or more motors in a manner such that the motors rotate with differing rotational speeds and/or differing rotational directions.

Implementing the subject matter disclosed herein may achieve various benefits. For instance, by implementing the disclosed principles, a single set of motors may control both (i) rotation of the cutting tool and (ii) cut depth adjustment of the cutting tool, which can reduce the design complexity of belt-driven CNC routers. For instance, a CNC router as disclosed herein may omit linear actuators for adjusting displacement of the router carriage relative to the sled. Furthermore, by implementing the disclosed principles, cut depth adjustments may be focused on the cutting tool and may refrain from adjusting the positioning of the entire router carriage and/or components connected thereto, which can contribute to improved cut precision and/or reduced software complexity.

Although examples described herein focus, in at least some respects, on implementing a cut adjustment system on belt-driven CNC routers, the principles described herein can be incorporated on other types of CNC routers and/or other types of rotational cutting devices/machines. For instance, implementations may be incorporated into gantry-based CNC systems, vertical machining centers, handheld routing devices, robotic machining platforms, or other automated or semi-automated machining systems. Additionally, while examples described herein reference routing operations, the disclosed systems may be used with various types of tools and material-processing devices, such as drilling tools, milling tools, grinding tools, polishing tools, engraving tools, marking tools, and/or laser-based or hybrid material-processing tools. For instance, the cutting tool coupled to the shaft may comprise interchangeable or modular tooling components, such that different tool types may be selectively secured to the shaft for performing different material-processing operations. In some instances, the shaft may be configured to receive different tool holders or tool interfaces that enable rapid switching between routing, drilling, engraving, or other operations without modification to the underlying cut depth adjustment system.

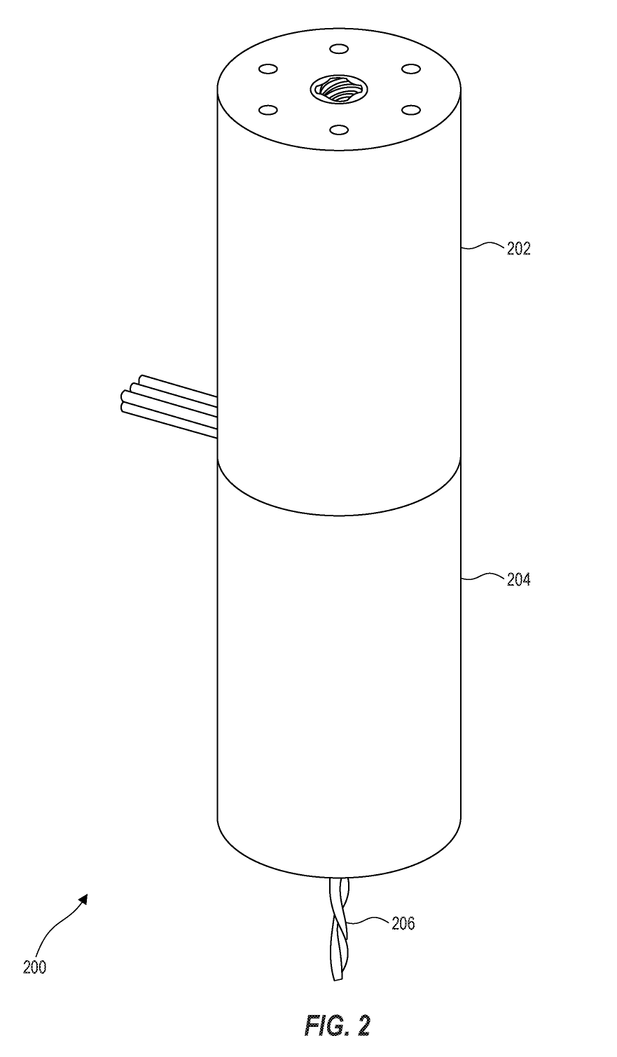

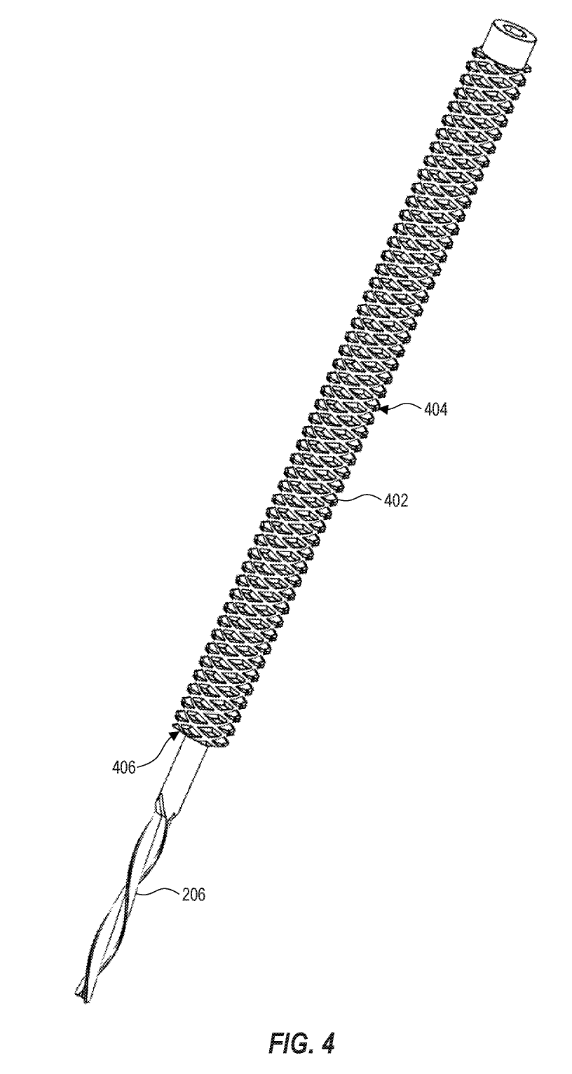

FIG. 2 illustrates a model of an example cut depth adjustment system 200. The cut depth adjustment system 200 includes a set of motors including a first motor 202 and a second motor 204. The cut depth adjustment system 200 further includes a shaft 402, which is illustrated in FIG. 4. As will be described in more detail hereinbelow, the first motor 202 and the second motor 204 may cooperate with one another to receive the shaft 402 (and a cutting tool 206 connected to the shaft 402) and may perform dual functions of (i) rotating the shaft 402 to perform cutting operations and (ii) adjusting the cut depth of the cutting tool 206. In some implementations, these dual functions may be achieved under different operating conditions of the set of motors, such that coordinated rotation of the motors corresponds to cutting operations (e.g., at substantially constant cut depth) and differential rotational operation between the motors corresponds to cut depth adjustment. The cut depth adjustment system 200 (or another embodiment of a cut depth adjustment system with similar features) may be implemented on a belt-driven CNC router (e.g., similar to belt-driven CNC router 100), or another type of CNC router or rotational machine. For instance, a cut depth adjustment system 200 may be mounted to a router carriage, and the cutting tool 206 may be extendable through an opening of a sled to which the router carriage is mounted to facilitate cutting of material as the sled and router carriage slide over the material (e.g., via operation of actuators and corresponding belts).

The first motor 202 and the second motor 204 may be configured to rotate at speeds suitable for routing operations (e.g., over 1,000 rpm, or within a range of about 5,000 rpm to about 30,000 rpm) and may be embodied in various ways. In one implementation, the first motor 202 and the second motor 204 comprise brushless DC motors with integrated hall effect sensors for facilitating precise speed control and/or motor position detection. In some implementations, the motors may be controlled using coordinated control frameworks that regulate relative rotational characteristics between motors to achieve desired cutting and positioning behaviors. In other embodiments, first and second motors of a cut depth adjustment system 200 may implement brushed DC motors (or other types of motors) and/or other speed/position control mechanisms (e.g., sensorless control systems, integrated or external sensors, field-oriented control, and/or other frameworks).

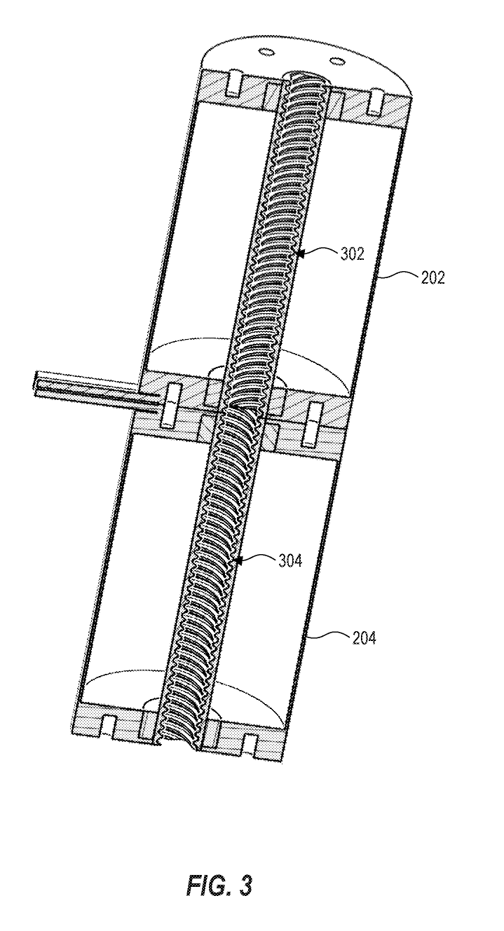

FIG. 3 illustrates a sectional view of the first motor 202 and second motor 204 described hereinabove with reference to FIG. 2. FIG. 3 illustrates the first motor 202 as defining a first threaded center hole 302 that has first thread characteristics. FIG. 3 also illustrates the second motor 204 as defining a second threaded center hole 304 that has second thread characteristics. As shown in FIG. 3, the first motor 202 and the second motor 204 are arranged adjacent to one another such that the central axes of the first threaded center hole 302 and the second threaded center hole 304 are coaxially aligned. The first threaded center hole 302 and the second threaded center hole 304 can thus combine to form a single threaded through-hole that extends through both the first motor 202 and the second motor 204 and that comprises different sections or regions with different thread characteristics (e.g., different thread pitches and/or thread orientations).

FIG. 3 illustrates a coupling interface 306 that facilitates coupling between the first motor 202 and the second motor 204. For instance, the illustrated coupling interface 306 is formed by recesses defined in both the first motor 202 and the second motor 204, with a coupling features being insertable into the recesses. The coupling features may contribute to maintaining axial and/or radial alignment between the first motor 202 and the second motor 204 during rotation. One will appreciate, in view of the present disclosure, that other coupling frameworks for maintaining axial and/or radial alignment between different motors of a set of motors of a cut depth adjustment system may be implemented in accordance with the presently disclosed subject matter, such as pilot features, bearing-supported alignment structures, shaft-coupled alignment structures, face-mounted structural alignment, spacer or shoulder features, rail or track-guided features, external housings, and/or others. In some instances, separate motors of a set of motors of a cut depth adjustment system are axially offset from one another, forming axial space or displacement therebetween (e.g., via one or more spacers or other intervening components).

In the example shown in FIG. 3, the first threaded center hole 302 and the second threaded center hole 304 each have T8 thread pitches with opposite thread orientations (e.g., with the first threaded center hole 302 having a left-handed thread orientation and with threaded center hole 304 having a right-handed thread orientation). Other thread characteristics (e.g., thread pitch, thread orientation) are possible for the first threaded center hole 302 and the second threaded center hole 304 of the first motor 202 and the second motor 204, respectively, provided that a difference exists in the thread characteristics of the first threaded center hole 302 and the second threaded center hole 304. For example, threaded center holes of first and second motors of a cut depth adjustment system may have different thread pitches with the same thread orientation (e.g., T8 for one threaded center hole and T12 for the other, with both thread pitches being either right-handed or left-handed), the same thread pitches with different thread orientations (e.g., similar to the example shown and described with reference to FIG. 3), or different thread pitches and different thread orientations (e.g., right-handed T8 for one threaded center hole and left-handed T12 for the other). Stated differently, for threaded center holes of first and second motors of a cut depth adjustment system according to the present disclosure, (i) the first thread pitch may be different from the second thread pitch and/or (ii) the first thread orientation may be different from the second thread orientation.

The first motor 202 and the second motor 204 can be controlled to rotate while engaged with the shaft 402 that holds the cutting tool 206 to facilitate rotation of and/or cut depth adjustments for the cutting tool 206 (e.g., to perform routing operations). FIG. 4 illustrates the example threaded shaft 402 of the cut depth adjustment system 200. The shaft 402 can be formed from any suitable material, such as tool steel, mild steel, or another material. In the example shown in FIG. 4, the shaft 402 includes exterior threads 404 formed via (i) cuts with the same thread pitch and orientation as the first threaded center hole 302 and (ii) cuts with the same thread pitch and orientation as the second threaded center hole 304. Such cuts can result in a feature structure similar to that shown in FIG. 4 (though other feature structures can result from different combinations of thread characteristics of the first threaded center hole 302 and the second threaded center hole 304 used to cut the exterior threads 404). Because the exterior threads 404 includes thread characteristics that match both the first threaded center hole 302 and the second threaded center hole 304, the shaft 402 can be configured to simultaneously threadedly engage with both the first threaded center hole 302 and the second threaded center hole 304.

In some instances, the different thread characteristics are cut into the shaft 402 in a non-overlapping manner (e.g., the exterior threads 404 can comprise different sections with different thread characteristics). As an example, a shaft of a cut depth adjustment system as described herein may comprise a distal section (positioned toward the cutting tool, near end 406) with first thread characteristics (e.g., for engaging with threads of the second threaded center hole 304), a middle section without thread features (e.g., which may comprise a reduced outer diameter to permit entry of the middle section into the first threaded center hole 302 and the second threaded center hole 304), and a proximal section with second thread characteristics (e.g., for engaging with threads of the first threaded center hole 302). In some instances, the shaft may comprise one or more modular or replaceable components to enable replacement or customization of shaft configurations.

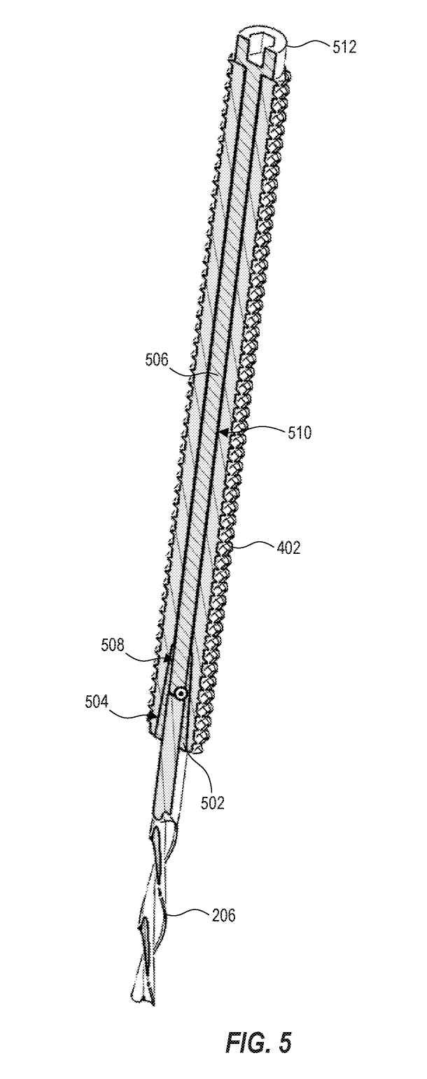

In some implementations, the shaft 402 may be configured to receive and secure the cutting tool 206 at an end 406 (e.g., distal end) of the shaft 402. FIG. 5 illustrates a sectional view of the shaft 402 and illustrates example componentry of the cutting tool 206 and/or the shaft 402 that can facilitate securement of the cutting tool 206 to the shaft 402. In the example shown in FIG. 5, the cutting tool 206 is connected to a collet 502 with an annular wedge shape. The collet 502 is configured to advance into an opening 504 of the shaft 402 and engage with a drawbar 506 at a threaded interface 508. The drawbar 506 is configured to extend through a through hole 510 of the shaft 402 and into engagement with the collet 502 at the threaded interface 508. Under such a configuration, when the drawbar 506 is rotated to tighten its engagement with the collet 502 at the threaded interface 508 (e.g., via a tool interface 512 of the drawbar 506), the drawbar 506 may urge the collet 502 toward the opening 504 of the shaft 402 and cause the opening 504 to exert force on the collet 502, causing the collet 502 to exert clamping force on the cutting tool 206 to secure the cutting tool 206 to the shaft 402.

Although FIG. 5 shows that the cutting tool 206 can secure to the shaft 402 via a machine taper framework, other connection frameworks may be used to facilitate securement of the cutting tool 206 to the shaft 402, such as collet-based retention systems, chuck-based retention systems, threaded interfaces, non-circular drive interfaces (e.g., hex or spline interfaces), clamping interfaces (e.g., set-screw or side-lock configurations), interference-fit systems (e.g., shrink-fit or hydraulic interfaces), and/or quick-change coupling systems (e.g., bayonet or modular coupling interfaces). In some instances, the cutting tool is integrally formed with the shaft for a cut depth adjustment system as described herein.

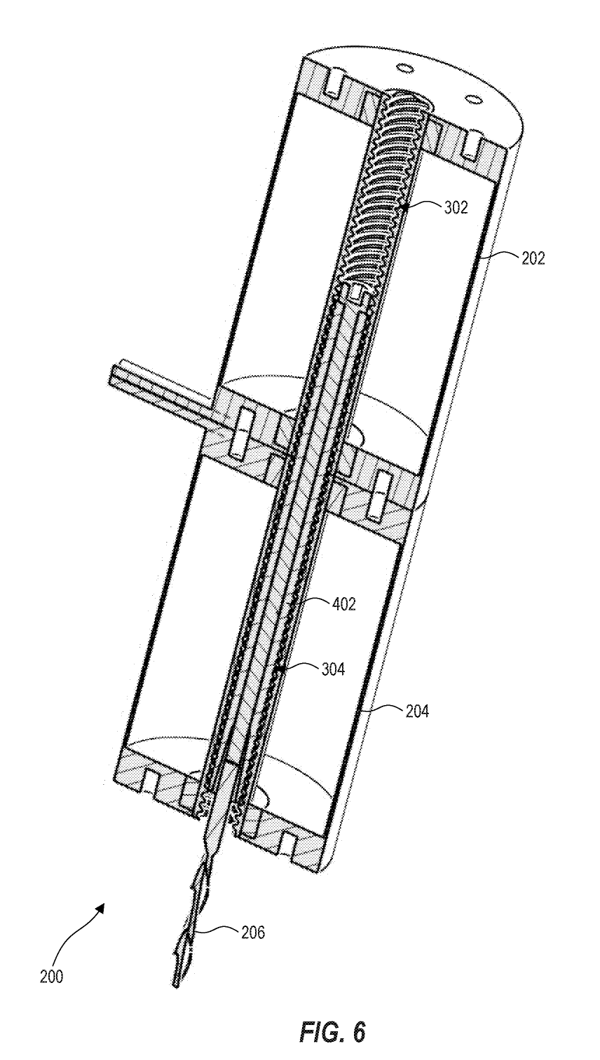

FIG. 6 illustrates a sectional view of the cut depth adjustment system 200 described hereinabove, with the cutting tool 206 secured to the shaft 402 and with the shaft 402 threadedly simultaneously engaged with the first threaded center hole 302 of the first motor 202 and with the second threaded center hole 304 of the second motor 204. Under the configuration shown in FIG. 6, rotation of the first motor 202 and the second motor 204 may be precisely controlled to facilitate different functions of the cutting tool 206. For instance, rotation of the first motor 202 and the second motor 204 at the same speed and in the same rotational direction may cause rotation of the shaft 402 and, correspondingly, the cutting tool 206, which can enable the cutting tool 206 to perform cutting sequences and/or operations when brought toward material (e.g., such as when the cut depth adjustment system 200 is mounted to a belt-driven CNC router with the cutting tool 206 extending through the opening of the sled toward a workpiece). When both the first motor 202 and the second motor 204 rotate with the same speed and in the same rotational direction, the position of the shaft 402 along the central axes of the first threaded center hole 302 and the second threaded center hole 304 may remain substantially constant, causing the cutting tool 206 to remain at a substantially constant cut depth. In some implementations, such coordinated rotation of the first motor 202 and the second motor 204 may correspond to a first operating condition in which rotational output of the shaft 402 is produced to drive the cutting tool 206 while maintaining a substantially constant axial position of the shaft 402. In some implementations, one motor may be controlled to maintain a substantially constant rotational speed to drive continuous rotation of the cutting tool, while another motor may be selectively controlled to deviate from the constant rotational speed to induce axial displacement of the shaft, thereby adjusting cut depth while maintaining rotational cutting functionality.

In some implementations, the cut depth adjustment system may include features that may contribute to positional accuracy and/or stability of the shaft. For example, preload mechanisms, spring-loaded interfaces, or dual-engagement structures may be implemented, which may reduce backlash between threaded interfaces. In some instances, damping elements or compliant structures may be incorporated to mitigate vibration or oscillation during operation, which may improve cutting precision and surface finish quality.

As another example, rotation of the first motor 202 and the second motor 204 at different speeds and in the same rotational direction may cause adjustment of the position of the shaft 402 along the central axes of the first threaded center hole 302 and the second threaded center hole 304. The direction of movement of the shaft 402 along the central axes is based on the relative speeds of the first motor 202 and the second motor 204 and the direction of rotation. In the example shown in FIG. 6 with the first threaded center hole 302 and the second threaded center hole 304 comprising oppositely oriented T8 threads, a relative difference of 1 rpm in the rotation speeds of the first motor 202 and the second motor 204 can result in an 8 millimeter per minute movement of the shaft 402 along the central axes of the first threaded center hole 302 and the second threaded center hole 304. Thus, with precise control of the relative speeds of the first motor 202 and the second motor 204, the cut depth of the cutting tool 206 (or the position of the cutting tool 206 and the shaft 402 along the central axes of the first threaded center hole 302 and the second threaded center hole 304) may also be precisely controlled. In some implementations, such differential rotational operation between the first motor 202 and the second motor 204 may correspond to a second operating condition in which differential rotational behavior between the motors causes relative axial motion between the shaft 402 and the threaded center holes to translate the shaft 402 along the coaxially aligned central axes, thereby adjusting the cut depth of the cutting tool 206. In some implementations, axial displacement of the shaft may be a function of a differential rotational relationship between the motors, such that a magnitude and direction of displacement correspond to a difference in rotational speed and/or direction between the motors in combination with thread characteristics of the engagement interfaces.

In some implementations, control of the motors may be configured such that rotational drive of the cutting tool is maintained while axial displacement is independently adjusted based on differential motor behavior. For instance, a first motor may be operated at a substantially constant speed to maintain tool rotation, while a second motor is controlled to vary its speed relative to the first motor to induce controlled axial movement of the shaft. Such configurations may allow continuous cutting operations to be performed while dynamically adjusting cut depth. In some implementations, the foregoing control behaviors may correspond to operation of the system under different operating conditions, such that coordinated motor operation corresponds to a cutting condition with substantially constant axial position and relative motor operation corresponds to a depth-adjustment condition involving axial translation of the shaft.

Control of the relative speeds of the first motor 202 and the second motor 204 can be accomplished via a control system (e.g., control system 150, conceptually depicted in FIGS. 1A and 1B) .The control system may perform operations via one or more processing units reading program instructions stored on one or more computer-readable recording media. In some implementations, the control system may implement closed-loop control frameworks that monitor one or more operational parameters (e.g., rotational speed, torque, position, current draw) and dynamically adjust motor operation to achieve desired cutting depth and/or rotational performance. For example, proportional-integral-derivative (PID) control, model-based control, or other feedback control strategies may be implemented to regulate relative motor speeds and/or maintain target positioning. In some instances, the control system may implement synchronization control between motors, calibration routines for establishing reference positions, and/or compensation mechanisms (e.g., backlash compensation or load-based adjustments) to improve positioning accuracy. In some implementations, the cut depth adjustment system 200 (and/or the belt-driven CNC router on which the cut depth adjustment system 200 is mounted) incorporates one or more sensor systems (e.g., sensor(s) 160, conceptually depicted in FIGS. 1A and 1B) to track the position of the cut depth of the cutting tool 206 during cutting operations/sequences to accurately maintain and/or adjust the cut depth of the cutting tool 206 in accordance with a desired cut trajectory. Additionally, or alternatively, the cut depth adjustment system 200 (and/or the CNC router or other tool on which the cut depth adjustment system 200 is mounted) utilizes a homing process (and/or homing sensors) to enable the cutting tool 206 to be brought to a known initial position, after which positioning of the cutting tool 206 may be controlled and/or inferred based on the control input provided to the first motor 202 and the second motor 204.

In some implementations, the control system may incorporate sensor feedback from one or more sensing components (e.g., rotational encoders, position sensors, current sensors, vibration sensors) to monitor system performance and adjust motor control signals accordingly. For instance, sensor data may be used to detect deviations from desired positioning, changes in load conditions, or tool wear characteristics, and may be used to dynamically adjust control inputs to maintain desired cutting performance.

In some instances, the first motor 202 and the second motor 204 may be driven with different rotational characteristics at high speeds (e.g., greater than 1,000 rpm) and/or low speeds (e.g., less than 1,000 rpm) to facilitate adjustment to the depth/positioning of the cutting tool 206 relative to the first motor 202 and the second motor 204. In some implementations, when operating at low speeds, the first motor 202 and the second motor 204 may be rotated in different directions to facilitate positional adjustment of the shaft 402 and/or the cutting tool 206 (e.g., to bring the shaft 402 to a position for changing or removing the cutting tool 206, and/or when performing non-cutting operations with the CNC router to which the cut depth adjustment system 200 is attached such as marking, etching, or engraving operations with different tooling).

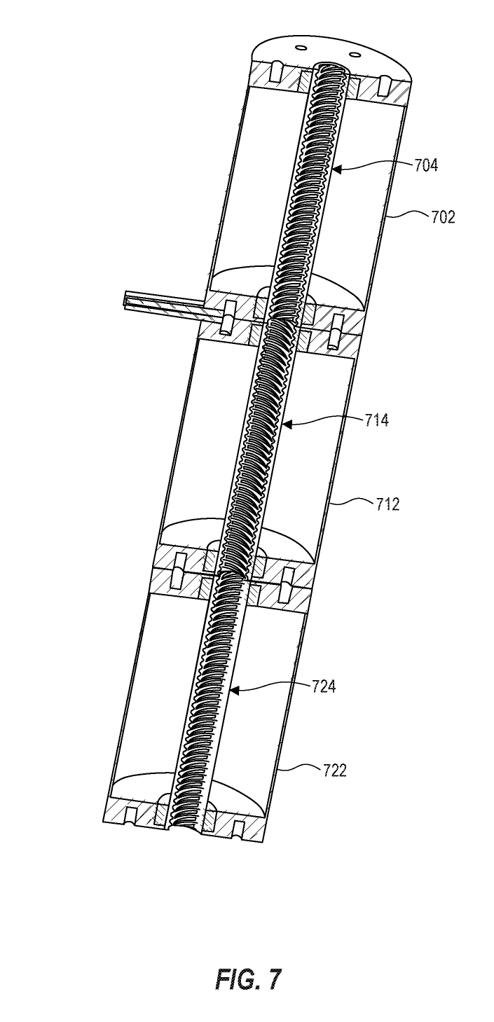

FIG. 7 illustrates an example cut depth adjustment system that includes a set of motors comprising a first motor 702, a second motor 712, and a third motor 722. As shown, each of the first motor 702, the second motor 712, and the third motor 722 defines a respective threaded center hole, including a first threaded center hole 704, a second threaded center hole 714, and a third threaded center hole 724. The threaded center holes 704, 714, and 724 are arranged such that their central axes are coaxially aligned, thereby forming a continuous threaded passage through the set of motors for receiving and engaging a threaded shaft (as discussed above, in some implementations, a discontinuous threaded passage may be formed by different motors of a cut depth adjustment system).

In the example shown in FIG. 7, the first threaded center hole 704 and the third threaded center hole 724 comprise the same thread characteristics, such as a same thread pitch and thread orientation, while the second threaded center hole 714 comprises different thread characteristics relative to the first threaded center hole 704 and the third threaded center hole 724. Under such a configuration, the threaded shaft may be simultaneously engaged with all three threaded center holes 704, 714, and 724, enabling coordinated interaction between the threaded shaft and the set of motors.

In some implementations, providing multiple motors with matching thread characteristics (e.g., the first motor 702 and the third motor 722) may enable reduction or compensation of backlash associated with threaded engagement between the motors and the threaded shaft. For instance, the first motor 702 and the third motor 722 may be controlled such that their rotational positions are slightly offset relative to one another, thereby causing opposing forces to be applied to the threaded shaft through their respective threaded interfaces. Such opposing forces may place the threaded shaft under tension within the threaded center holes 704 and 724, which can reduce play or slack associated with manufacturing tolerances in the threaded interfaces. In some instances, a degree of offset between the motors may be dynamically controlled (e.g., via software control of motor rotation) to adjust the amount of tension applied to the threaded shaft, thereby enabling compensation for variations in backlash over time or across different operating conditions.

In some implementations, the second motor 712, having different thread characteristics, may cooperate with the first motor 702 and the third motor 722 to facilitate axial translation of the threaded shaft in accordance with differential rotational operation between motors, as described herein. In some instances, the combination of motors with differing and matching thread characteristics may provide both cut depth adjustment functionality and improved mechanical stability and/or precision during operation.

Although FIG. 7 illustrates a configuration with three motors, one will appreciate, in view of the present disclosure, that any number of motors may be implemented in a coaxially aligned arrangement, and that any subset of such motors may share thread characteristics while other motors may have differing thread characteristics. For example, although FIG. 7 illustrates the first and third motors 702 and 722 (having common thread characteristics) arranged with the second motor 712 intervening therebetween, other configurations are possible, such as where motors with common thread characteristics are arranged adjacent to one another. Configurations may be selected based on desired performance characteristics, including cut depth control, mechanical stability, cost considerations, and/or other design factors.

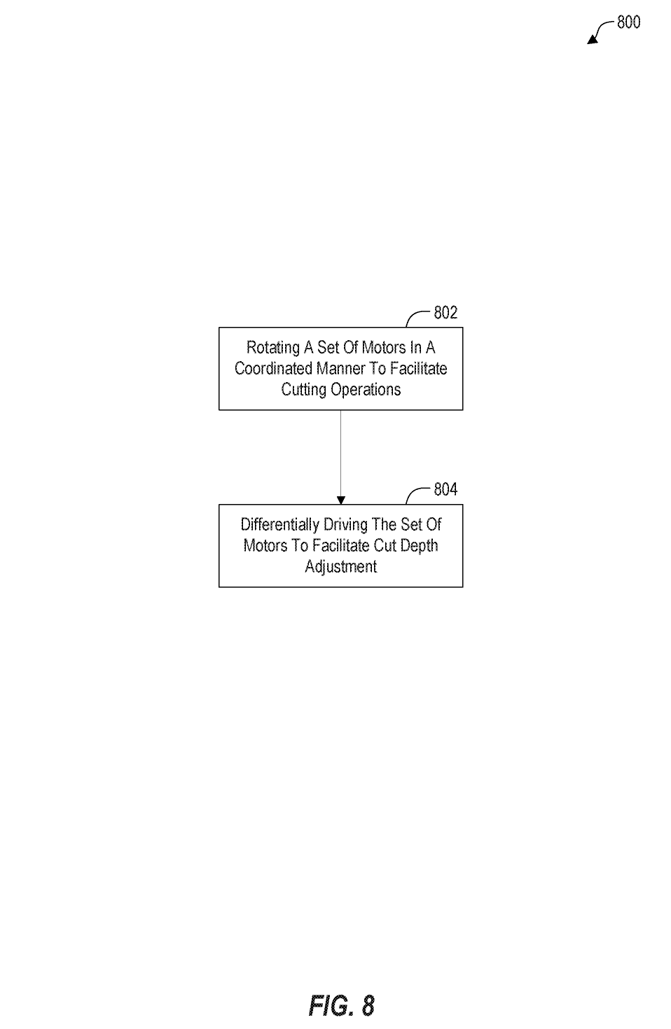

FIG. 8 illustrates a flow diagram 800 depicting example acts associated with operating a cut depth adjustment system (e.g., cut depth adjustment system 200) to facilitate cutting operations and cut depth adjustments using coordinated and differential motor control. The acts described with reference to FIG. 8 may be performed using one or more components of the systems described herein, such as the first motor 202, the second motor 204, the threaded shaft 402, the cutting tool 206, control system 150, sensor(s) 160, etc.

Act 802 includes rotating a set of motors in a coordinated manner to facilitate cutting operations. For instance, act 802 may include controlling the first motor 202 and the second motor 204 such that the motors rotate at substantially the same rotational speed and in a same rotational direction. Under such coordinated rotation, the threaded shaft 402, which may be simultaneously threadedly engaged with the first threaded center hole 302 and the second threaded center hole 304, may rotate without substantial axial displacement relative to the motors. As a result, the cutting tool 206 coupled to the threaded shaft 402 may be driven rotationally to perform cutting operations while maintaining a substantially constant cut depth. In some implementations, coordinated rotation may correspond to operation under a first operating condition, as described herein, and may be maintained via control of the motors using a control system 150 configured to regulate motor speeds and/or rotational directions.

Act 804 includes differentially driving the set of motors to facilitate cut depth adjustment. For instance, act 804 may include controlling the first motor 202 and the second motor 204 such that the motors rotate with differing rotational speeds and/or differing rotational directions. Under such differential rotational operation, the threaded engagement between the threaded shaft 402 and the first threaded center hole 302 and the second threaded center hole 304 may cause relative axial motion of the threaded shaft 402 along the coaxially aligned central axes of the threaded center holes. This axial motion may translate the cutting tool 206 along the axis, thereby adjusting the cut depth of the cutting tool 206 relative to a workpiece. In some implementations, differential driving of the motors may correspond to operation under a second operating condition, and a magnitude and direction of the axial translation may be based at least in part on a difference in rotational characteristics (e.g., rotational speed and/or direction) of the first motor 202 and the second motor 204 and/or on thread characteristics of the threaded interfaces.

In some implementations, one or more acts of flow diagram 800 may be performed iteratively or in an alternating manner during operation of the cut depth adjustment system. For example, coordinated rotation may be maintained during cutting sequences, while differential rotation may be intermittently applied to adjust cut depth in accordance with a desired cutting trajectory. Additionally, or alternatively, one or more acts may be performed in parallel, repeated, omitted, or reordered based on system configuration and operational requirements. Control of the acts may be performed using a control system (e.g., control system 150) which may be configured to receive input signals (e.g., user input, program instructions, or sensor data) and generate control signals to regulate operation of the motors.

Disclosed embodiments include at least those represented in the following numbered clauses:

Clause 1. A cut depth adjustment system, comprising: a set of motors, the set of motors comprising at least: a first motor comprising a first threaded center hole, the first threaded center hole comprising a first thread pitch and a first thread orientation; and a second motor comprising a second threaded center hole, wherein central axes of the first threaded center hole and the second threaded center hole are coaxially aligned, the second threaded center hole comprising a second thread pitch and a second thread orientation, wherein (i) the first thread pitch is different from the second thread pitch or (ii) the first thread orientation is different from the second thread orientation; a threaded shaft configured to simultaneously threadedly engage with both the first threaded center hole and the second threaded center hole; and a cutting tool coupled or couplable to the threaded shaft, wherein, when the threaded shaft is simultaneously threadedly engaged with both the first threaded center hole and the second threaded center hole and when the cutting tool is coupled to the threaded shaft: the set of motors is configurable to operate under a first operating condition in which coordinated rotation of the first motor and the second motor produces rotational output of the threaded shaft to drive the cutting tool for cutting operations while maintaining a substantially constant axial position of the threaded shaft, and the set of motors is configurable to operate under a second operating condition in which differential rotational operation of the first motor and the second motor causes axial motion of the threaded shaft relative to the first and second threaded center holes to translate the threaded shaft along the coaxially aligned central axes, thereby adjusting a cut depth of the cutting tool.

Clause 2. The cut depth adjustment system of clause 1, wherein the first thread pitch is different from the second thread pitch and the first thread orientation is the same as the second thread orientation.

Clause 3. The cut depth adjustment system of clause 1, wherein the first thread orientation is different from the second thread orientation.

Clause 4. The cut depth adjustment system of clause 1, wherein the set of motors further comprises at least a third motor configured to engage the threaded shaft.

Clause 5. The cut depth adjustment system of clause 1, wherein, under the first operating condition, the first motor and the second motor are controlled to rotate at substantially the same rotational speed and in a same rotational direction.

Clause 6. The cut depth adjustment system of clause 1, wherein, under the second operating condition, the first motor and the second motor are controlled to rotate at different rotational speeds.

Clause 7. The cut depth adjustment system of clause 1, wherein, under the second operating condition, the first motor and the second motor are controlled to rotate in different rotational directions.

Clause 8. The cut depth adjustment system of clause 1, wherein, under the first operating condition and the second operating condition, the first motor is configured to maintain a substantially constant rotational speed.

Clause 9. The cut depth adjustment system of clause 1, further comprising a control system configured to control rotational speeds of the first motor and the second motor to selectively operate the set of motors under the first operating condition or the second operating condition.

Clause 10. The cut depth adjustment system of clause 9, wherein the control system comprises one or more sensors configured to detect at least one of rotational speed, position, or torque associated with the threaded shaft or the motors.

Clause 11. The cut depth adjustment system of clause 9, wherein the control system is configured to implement a feedback control scheme to maintain the substantially constant axial position of the threaded shaft under the first operating condition.

Clause 12. The cut depth adjustment system of clause 1, wherein the cutting tool is removably couplable to the threaded shaft via a collet, chuck, or tool holder interface.

Clause 13. The cut depth adjustment system of clause 1, wherein the cut depth adjustment system is configured for mounting to a CNC router.

Clause 14. A cut depth adjustment system, comprising: a set of motors, the set of motors comprising at least: a first motor comprising a first threaded center hole, the first threaded center hole comprising a first thread pitch and a first thread orientation; and a second motor comprising a second threaded center hole, wherein central axes of the first threaded center hole and the second threaded center hole are coaxially aligned, the second threaded center hole comprising a second thread pitch and a second thread orientation, wherein (i) the first thread pitch is different from the second thread pitch or (ii) the first thread orientation is different from the second thread orientation; a threaded shaft configured to simultaneously threadedly engage with both the first threaded center hole and the second threaded center hole; and a cutting tool coupled or couplable to the threaded shaft, wherein, when the threaded shaft is simultaneously threadedly engaged with both the first threaded center hole and the second threaded center hole and when the cutting tool is coupled to the threaded shaft: rotation of the first motor and the second motor at different speeds in a same rotational direction adjusts a cut depth of the cutting tool along the central axes of the first threaded center hole and the second threaded center hole, rotation of the first motor and the second motor in different rotational directions adjusts the cut depth of the cutting tool along the central axes of the first threaded center hole and the second threaded center hole, and rotation of the first motor and the second motor at a same speed in the same rotational direction maintains the cut depth of the cutting tool along the central axes of the first threaded center hole and the second threaded center hole.

Clause 15. The cut depth adjustment system of clause 14, wherein the first thread pitch is different from the second thread pitch and the first thread orientation is the same as the second thread orientation.

Clause 16. The cut depth adjustment system of clause 14, wherein the first thread orientation is different from the second thread orientation.

Clause 17. The cut depth adjustment system of clause 14, further comprising a control system configured to control rotational speeds or rotational directions of the first motor and the second motor to selectively operate under conditions that maintain the cut depth or adjust the cut depth.

Clause 18. The cut depth adjustment system of clause 14, wherein the set of motors further comprises at least a third motor configured to engage the threaded shaft.

Clause 19. The cut depth adjustment system of clause 14, wherein the cut depth adjustment system is configured for mounting to a router carriage of a belt-drive CNC router.

Clause 20. A belt-driven CNC router, comprising: a sled; a router carriage mounted to the sled; a plurality of actuators mounted to the router carriage, each of the plurality of actuators being configured to extend and retract a corresponding belt to facilitate sliding of the router carriage and the sled over a workpiece; and a cut depth adjustment system mounted to the router carriage, the cut depth adjustment system comprising: a first motor comprising a first threaded center hole, the first threaded center hole comprising a first thread pitch and a first thread orientation; a second motor comprising a second threaded center hole, the second motor being arranged adjacent to the first motor such that central axes of the first threaded center hole and the second threaded center hole are coaxially aligned, the second threaded center hole comprising a second thread pitch and a second thread orientation, wherein (i) the first thread pitch is different from the second thread pitch or (ii) the first thread orientation is different from the second thread orientation; and a threaded shaft configured to simultaneously threadedly engage with both the first threaded center hole and the second threaded center hole, the threaded shaft being configured to receive and secure a cutting tool at an end of the threaded shaft, wherein, when the threaded shaft is simultaneously threadedly engaged with both the first threaded center hole and the second threaded center hole and when the threaded shaft secures the cutting tool: rotation of the first motor and the second motor at different speeds in a same rotational direction adjusts a cut depth of the cutting tool along the central axes of the first threaded center hole and the second threaded center hole, and rotation of the first motor and the second motor at a same speed in the same rotational direction maintains the cut depth of the cutting tool along the central axes of the first threaded center hole and the second threaded center hole.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

What is claimed is:

1. A cut depth adjustment system, comprising:
a set of motors, the set of motors comprising at least:
a first motor comprising a first threaded center hole, the first threaded center hole comprising a first thread pitch and a first thread orientation; and
a second motor comprising a second threaded center hole, wherein central axes of the first threaded center hole and the second threaded center hole are coaxially aligned, the second threaded center hole comprising a second thread pitch and a second thread orientation, wherein (i) the first thread pitch is different from the second thread pitch or (ii) the first thread orientation is different from the second thread orientation;
a threaded shaft configured to simultaneously threadedly engage with both the first threaded center hole and the second threaded center hole; and
a cutting tool coupled or couplable to the threaded shaft, wherein, when the threaded shaft is simultaneously threadedly engaged with both the first threaded center hole and the second threaded center hole and when the cutting tool is coupled to the threaded shaft:
the set of motors is configurable to operate under a first operating condition in which coordinated rotation of the first motor and the second motor produces rotational output of the threaded shaft to drive the cutting tool for cutting operations while maintaining a substantially constant axial position of the threaded shaft, and
the set of motors is configurable to operate under a second operating condition in which differential rotational operation of the first motor and the second motor causes axial motion of the threaded shaft relative to the first and second threaded center holes to translate the threaded shaft along the coaxially aligned central axes, thereby adjusting a cut depth of the cutting tool.

2. The cut depth adjustment system of claim 1, wherein the first thread pitch is different from the second thread pitch and the first thread orientation is the same as the second thread orientation.

3. The cut depth adjustment system of claim 1, wherein the first thread orientation is different from the second thread orientation.

4. The cut depth adjustment system of claim 1, wherein the set of motors further comprises at least a third motor configured to engage the threaded shaft.

5. The cut depth adjustment system of claim 1, wherein, under the first operating condition, the first motor and the second motor are controlled to rotate at substantially the same rotational speed and in a same rotational direction.

6. The cut depth adjustment system of claim 1, wherein, under the second operating condition, the first motor and the second motor are controlled to rotate at different rotational speeds.

7. The cut depth adjustment system of claim 1, wherein, under the second operating condition, the first motor and the second motor are controlled to rotate in different rotational directions.

8. The cut depth adjustment system of claim 1, wherein, under the first operating condition and the second operating condition, the first motor is configured to maintain a substantially constant rotational speed.

9. The cut depth adjustment system of claim 1, further comprising a control system configured to control rotational speeds of the first motor and the second motor to selectively operate the set of motors under the first operating condition or the second operating condition.

10. The cut depth adjustment system of claim 9, wherein the control system comprises one or more sensors configured to detect at least one of rotational speed, position, or torque associated with the threaded shaft or the motors.

11. The cut depth adjustment system of claim 9, wherein the control system is configured to implement a feedback control scheme to maintain the substantially constant axial position of the threaded shaft under the first operating condition.

12. The cut depth adjustment system of claim 1, wherein the cutting tool is removably couplable to the threaded shaft via a collet, chuck, or tool holder interface.

13. The cut depth adjustment system of claim 1, wherein the cut depth adjustment system is configured for mounting to a CNC router.

14. A cut depth adjustment system, comprising:
a set of motors, the set of motors comprising at least:
a first motor comprising a first threaded center hole, the first threaded center hole comprising a first thread pitch and a first thread orientation; and
a second motor comprising a second threaded center hole, wherein central axes of the first threaded center hole and the second threaded center hole are coaxially aligned, the second threaded center hole comprising a second thread pitch and a second thread orientation, wherein (i) the first thread pitch is different from the second thread pitch or (ii) the first thread orientation is different from the second thread orientation;
a threaded shaft configured to simultaneously threadedly engage with both the first threaded center hole and the second threaded center hole; and
a cutting tool coupled or couplable to the threaded shaft, wherein, when the threaded shaft is simultaneously threadedly engaged with both the first threaded center hole and the second threaded center hole and when the cutting tool is coupled to the threaded shaft:
rotation of the first motor and the second motor at different speeds in a same rotational direction adjusts a cut depth of the cutting tool along the central axes of the first threaded center hole and the second threaded center hole,
rotation of the first motor and the second motor in different rotational directions adjusts the cut depth of the cutting tool along the central axes of the first threaded center hole and the second threaded center hole, and
rotation of the first motor and the second motor at a same speed in the same rotational direction maintains the cut depth of the cutting tool along the central axes of the first threaded center hole and the second threaded center hole.

15. The cut depth adjustment system of claim 14, wherein the first thread pitch is different from the second thread pitch and the first thread orientation is the same as the second thread orientation.

16. The cut depth adjustment system of claim 14, wherein the first thread orientation is different from the second thread orientation.

17. The cut depth adjustment system of claim 14, further comprising a control system configured to control rotational speeds or rotational directions of the first motor and the second motor to selectively operate under conditions that maintain the cut depth or adjust the cut depth.

18. The cut depth adjustment system of claim 14, wherein the set of motors further comprises at least a third motor configured to engage the threaded shaft.

19. The cut depth adjustment system of claim 14, wherein the cut depth adjustment system is configured for mounting to a router carriage of a belt-drive CNC router.

20. A belt-driven CNC router, comprising:
a sled;
a router carriage mounted to the sled;
a plurality of actuators mounted to the router carriage, each of the plurality of actuators being configured to extend and retract a corresponding belt to facilitate sliding of the router carriage and the sled over a workpiece; and
a cut depth adjustment system mounted to the router carriage, the cut depth adjustment system comprising:
a first motor comprising a first threaded center hole, the first threaded center hole comprising a first thread pitch and a first thread orientation;
a second motor comprising a second threaded center hole, the second motor being arranged adjacent to the first motor such that central axes of the first threaded center hole and the second threaded center hole are coaxially aligned, the second threaded center hole comprising a second thread pitch and a second thread orientation, wherein (i) the first thread pitch is different from the second thread pitch or (ii) the first thread orientation is different from the second thread orientation; and
a threaded shaft configured to simultaneously threadedly engage with both the first threaded center hole and the second threaded center hole, the threaded shaft being configured to receive and secure a cutting tool at an end of the threaded shaft, wherein, when the threaded shaft is simultaneously threadedly engaged with both the first threaded center hole and the second threaded center hole and when the threaded shaft secures the cutting tool:
rotation of the first motor and the second motor at different speeds in a same rotational direction adjusts a cut depth of the cutting tool along the central axes of the first threaded center hole and the second threaded center hole, and
rotation of the first motor and the second motor at a same speed in the same rotational direction maintains the cut depth of the cutting tool along the central axes of the first threaded center hole and the second threaded center hole.
